(19) United States
(12) Patent Application Publication
(10) Pub. No.: US 2020/0215838 A1
(43) Pub. Date: Jul. 9, 2020

(54) Gown System and Corresponding Methods

(71) Applicant: Medline Industries, Inc, Northfield, IL (US)

(72) Inventors: Nicholas Burghardt, Atlanta, GA (US); Jessica Vardas, Skokie, IL (US)

(21) Appl. No.: 16/264,469

(22) Filed: Jan. 31, 2019

Related U.S. Application Data
(60) Provisional application No. 62/788,380, filed on Jan. 4, 2019.

(51) Int. Cl. B42D 15/02; A41D 13/12; B65D 85/00

(52) U.S. Cl. CPC B42D 15/02; B65D 85/00; A41D 13/1236

(57) ABSTRACT

A system, includes a gown (100), optionally a drape (200), and a handbill (500). The handbill includes a physical substrate (501) defining a first major face (502) and a second major face (503). A package (400), which can be transparent, ha situated therein the gown in a folded state, the drape in a folded state, and the handbill with the handbill abutting an interior surface (901) of the package. The handbill includes an instruction (503) disposed along the first major face to pass the substrate beneath a door after transforming the gown from the folded state to a donned state.

### CROSS REFERENCE TO PRIOR APPLICATIONS

This application claims priority and benefit under 35 U.S.C. § 119(e) from U.S. Provisional Application No. 62/788,380, filed Jan. 4, 2019, which is incorporated by reference for all purposes.

### BACKGROUND

### Technical Field

This disclosure relates generally to apparel systems, and more particularly to disposable medical gown systems.

### Background Art

When a patient visits a physician, they are routinely asked to disrobe for the examination or procedure. Sometimes, they are asked to don a gown, which may be disposable. Such gowns help to prevent the transmission of germs and microbes. Additionally, they provide a privacy function and help to preserve patient dignity by covering the patient's body prior to examination or prior to a medical procedure.

After being asked to disrobe, the medical practitioner then generally just leaves the room. This can leave the patient wondering, for example, where to disrobe, where to put their clothes, how long they have to disrobe and don the gown until the medical practitioner returns, or if any other medical practitioners may enter the room unexpectedly while they are still disrobed. It would be advantageous to have a system that makes the process of disrobing and donning a gown more efficient.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a front view of one explanatory gown in accordance with one or more embodiments of the disclosure.

FIG. 2 illustrates a rear view of one explanatory gown in accordance with one or more embodiments of the disclosure.

FIG. 3 illustrates one explanatory drape in accordance with one or more embodiments of the disclosure.

FIG. 4 illustrates one explanatory package in accordance with one or more embodiments of the disclosure.

FIG. 5 illustrates a front view of one explanatory handbill in accordance with one or more embodiments of the disclosure.

FIG. 6 illustrates a rear view of one explanatory handbill in accordance with one or more embodiments of the disclosure.

FIG. 7 illustrates one explanatory system in accordance with one or more embodiments of the disclosure.

FIG. 8 illustrates another view of one explanatory system in accordance with one or more embodiments of the disclosure.

FIG. 9 illustrates one explanatory packaged system in accordance with one or more embodiments of the disclosure.

FIG. 10 illustrates one explanatory method in accordance with one or more embodiments of the disclosure.

FIG. 11 illustrates another explanatory method in accordance with one or more embodiments of the disclosure.

FIG. 12 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that when a patient visits a hospital or doctor's office for an examination or a procedure they are frequently asked to disrobe. They may then be asked to don a gown or cover themselves with a drape. However, embodiments of the disclosure contemplate that medical professionals seldom provide any additional instruction, such as where to disrobe, where to put their “street” clothes, how long a patient has to disrobe and don the gown or cover with the drape, or what to do once they have successfully disrobed and donned the gown or covered with the drape. Frequently, patients are left anxious and alone until a nurse or doctor comes back to check on the patient's status.

Advantageously, embodiments of the disclosure solve all of these problems. In one or more embodiment, upon entering an exam or procedure room, the patient is handed a lovely, complete, sealed, attractive system that includes one or more of a gown or a drape sealed in a package. In one or more embodiments the package is transparent. For example, the package can be made from polyethylene or another transparent plastic material.

In one or more embodiments, a handbill is sealed within the package such that a major face of the handbill is visible through the transparent package. In one or more embodiments, the handbill comprises an inviting instruction disposed on a first major face. In one or more embodiments, the instruction instructs the patient to “get comfortable” in their gown. Alternatively, the instruction could instruct the patient to “get comfortable” under the drape. Of course, combinations of these instructions could be used as well. Other instructions will be obvious to those of ordinary skill in the art having the benefit of this disclosure. Advantageously, this instruction provides a welcoming message that helps to reduce the patient's stress level while encountering the awkward situation of disrobing in a clinical space. The instruction further informs the patient of exactly what to do.

In addition to this instruction, in one or more embodiments the handbill also includes an instruction to pass the substrate beneath a door after transforming the gown from a folded state to a donned state. This instruction can further indicate passage of the substrate beneath the door after transforming the gown from the folded state to the donned state should occur with a second major face of the handbill facing upward. In one or more embodiments, the second major face of the handbill comprises a visual indicator. In one or more embodiments, the visual indicator comprises a notification that the gown has been transitioned from the folded state to a donned state.

Illustrating by example, the visual indicator disposed on the second major face of the handbill could include the words: “Ready. Come on in.” By using the handbill functionally as a physical vehicle to translate the visual indicator beneath the door, medical personnel are advantageously instantly alerted to the fact that the patient has disrobed, donned the gown and/or covered with the drape, and is ready for medical personnel to enter the room. Advantageously, this eliminates the anxiety, the waiting, and makes the overall medical examination or procedure process more efficient.

In one embodiment, a system includes a gown, a drape, and a handbill. In one or more embodiments, the handbill comprises a physical substrate defining a first major face and a second major face. In one or more embodiment, the gown is folded, thereby transforming it from an unfolded state to a folded state. Similarly, the drape can be folded to transform it from an unfolded state to a folded state.

In one or more embodiments, the folded drape and folded gown are placed into a transparent package. Thus, the transparent package includes situated therein the gown in a folded state, the drape in a folded state, and the handbill. In one or more embodiments, the handbill is placed into the transparent package with a major face abutting an interior surface of the package.

In one or more embodiments, the handbill comprises an instruction disposed along the first major face to pass the substrate beneath a door or other privacy structure, such as a curtain, after transforming the gown from the folded state to a donned state. Thus, when the user disrobes, and dons the gown, they know to use the substrate to functionally translate the handbill, with the visual indicator facing upward, under the door from the interior of a room to the exterior. This functional relationship between substrate and visual indicator provides a notifying function to medical personnel that the patient is ready for them to enter the room.

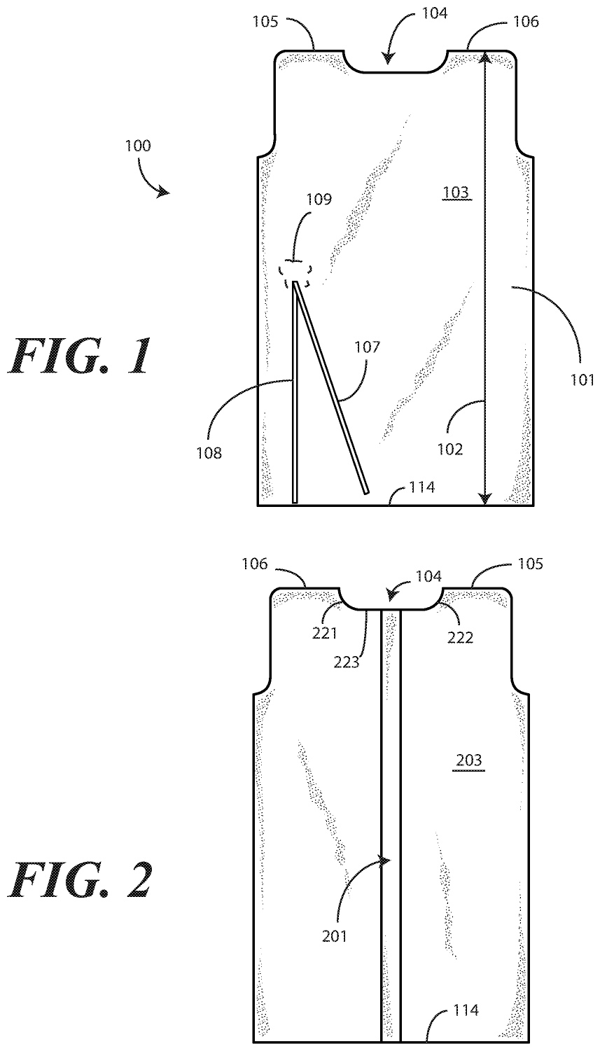

Turning now to FIGS. 1 and 2, illustrated therein is one example of a gown 100 configured in accordance with one or more embodiments of the disclosure. In one or more embodiments, the gown 100 includes a body-covering portion 101. In one or more embodiments, the body-covering portion 101 is configured to wrap about, and at least partially cover, the torso of a wearer.

In one or more embodiments, the body-covering portion 101 is manufactured from a single, unitary layer of non-woven fabric. Examples include spunlace, spunbond, and blends of polyester, polypropylene, and/or polyethelyne, tissue/polyethylene/tissue as well as combinations thereof. Suppliers of such materials include Cardinal Health in Dublin, Ohio, Kimberly Clark in Neenah, Wis., Tidi Products, LLC in Neenah, Wis., Graham, Graham Medical Products in Green Bay, Wis., Molnycke Health Care in Newtown, Pa., and Precept Medical Products, Inc., in Arden, N.C. The non-woven fabric can be a disposable material, and optionally can include a water resistant lining that prevents the passage of fluids through the body-covering portion 101. Other materials suitable for use in gowns will be obvious to those of ordinary skill in the art having the benefit of this disclosure.

The gown 100 can be manufactured in a variety of ways. For instance, in one embodiment the body-covering portion 101 is a single piece of material. In other embodiments, the body-covering portion 101 is configured as separate sections that are stitched, ultrasonically sealed, or otherwise attached together. Where included, the sleeves may be attached to the body-covering portion 101 by stitching, ultrasonic sealing, or other appropriate method of attachment. Similarly, the ties 107,108 may be integrated with the body-covering portion 101, or may be attached using glue, tape, stitching, ultrasonic sealing, or other appropriate attachment method.

In one embodiment, the length 102 of the gown 100 is configured to run from a wearer's shoulder to below their knee. In a “regular” size, this length 102 can be between 48.50″ and 50.50″ in one embodiment. For an “extra large” size, this length 102 can be between 51.00″ and 53.00″ in one embodiment. Other dimensions will be obvious to those of ordinary skill in the art having the benefit of this disclosure.

In one embodiment, the gown 100 may optionally include pockets or other surface features. The gown 100 may be manufactured in various colors. In one or more embodiments, the gown 100 is blue, as that color is particularly well suited for medical procedures due to its high visibility and easy differentiation from a patient's skin.

In the illustrative embodiment of FIGS. 1 and 2, the body-covering portion 101 includes a front portion 103 and a rear portion 203. The front portion 103 is configured as a frontal body-covering portion in that covers the frontal portion of some or all of a user's body in one or more embodiments. In another embodiment, the front portion 103 is configured to cover the frontal portion of some or all of a user's torso when the user is wearing the gown 100. The rear portion 203 is configured to cover the rear portion of some or all of a user's body in one or more embodiments. In another embodiment, the rear portion 203 is configured to cover the rear portion of some or all of a user's torso when the user is wearing the gown 100.

In the illustrative example of FIGS. 1 and 2, the rear portion 203 has a substantially similar length with the front portion 103. In other embodiments, the gown 100 can be configured differently, however. In one embodiment, for example, the front portion 103 will be longer than the rear portion 203, thereby covering more of the wearer's body in the front than the rear. In another embodiment, the front portion 103 will be shorter than the rear portion 203, thereby covering less of the wearer's body in the front than in the rear.

In one embodiment, the body-covering portion 101 defines a head insertion aperture 104 through which a user may insert their head when donning the gown 100. In the illustrative embodiment of FIGS. 1 and 2, the head insertion aperture 104 is disposed between the front portion 103 and the rear portion 203, and is surrounded by shoulder portions 105,106 of the body-covering portion 101.

The perimeter of the head insertion aperture 104 can take a variety of shapes. For example, in the illustrative embodiment of FIGS. 1 and 2, the head insertion aperture 104 has a curved-to-flat-to-curved contour, with two rounded side edges 221,222 radially interfacing with a substantially flat contour 223. Other embodiments may include different heat insertion aperture contours.

In one embodiment, the body-covering portion 101 defines an opening 201. In this illustrative embodiment, the front portion 103 of the gown 100 is configured, in one embodiment, to be placed against the front of the torso of a wearer. The body-covering portion 101 then wraps around, with a first side of the body-covering portion 101 and a second side of the body-covering portion 101 terminating at edges on each side of the opening 201. The opening 201 in this embodiment has a left side and a right side, and is configured as a slit, i.e., a long, narrow cut or opening, that runs the length 102 of the rear side 203 of the body-covering portion 101. Said differently, the slit runs up the back of the gown 100. In other embodiments, the opening 201 can be disposed along the front portion 103 of the gown 100, with the rear portion 203 being placed against the rear of the torso of a wearer. In such an embodiment, body-covering portion 101 then wraps around, with a first side of the body-covering portion 101 and a second side of the body-covering portion 101 terminating at edges on each side of the opening 201 in front of the wearer.

The opening can be used to assist in donning the gown. For instance, a user may open the opening 201 and pass their head, shoulders, and/or torso portions through the opening 201 when donning the gown. Said differently, the right side and left side of the opening 201 can be configured to permit the wearer to don the gown 100 by wrapping the right side and left side about the wearer's torso. The opening 201 in this embodiment extends distally along the rear portion 203 from the head insertion aperture 104 to a base of the body-covering portion 101.

In one embodiment, to further assist the user in removing the gown, the non-woven fabric is configured so as to be tearable by a wearer. For example, to non-woven fabric may have a tensile strength of between four and ten pounds. Thus, if a user were to grasp opposing sides of a section of the non-woven fabric, and then pull with a force of between four and ten pounds, the fabric would tear. Accordingly, a non-woven fabric that is easily tearable by a wide range of wearers, e.g., male and female wearers, may be selected for construction of the gown 100 in accordance with one or more embodiments.

In the illustrative embodiment of FIGS. 1 and 2, the gown 100 is sleeveless. However, in other embodiments a first sleeve and a second sleeve that extend distally from the body-covering portion 101 can be included. Where included, the first sleeve and the second sleeve can be configured to receive wearer's arms when the gown 100 is donned. It will be clear to those of ordinary skill in the art having the benefit of disclosure that embodiments of the disclosure are not so limited. Gowns in accordance with embodiments of the disclosure may equally be configured with short sleeves, for example, as a particular application may warrant.

The bottom of the gown 100 can take a variety of shapes. For example, in the illustrative embodiment of FIGS. 1 and 2, the base member 114 of the gown 100 is substantially flat. However, in another embodiment the base member 114 can substantially mirror the shape of the perimeter of the head insertion aperture 104.

As shown in FIG. 1, in one or more embodiments the gown 100 includes one or more tie members 107,108 coupled to, and extending from, the body-covering portion 101. The tie members 107,108 can be attached to the body-covering portion 101 in a variety of ways. In one embodiment, the tie members 107,108 are sewn to the body-covering portion 101. In another embodiment, the tie members 107,108 are adhesively attached to the body-covering portion 101. In another embodiment, the tie members 107,108 are thermally bonded to the body-covering portion 101. Other attachment methods will be obvious to those of ordinary skill in the art.

In one or more embodiments, the one or more tie members 107,108 can be tied together to close the opening 201. For example, in this embodiment one tie 107 attaches to the front side 103 of the body-covering portion 101. A second tie 108 can attach to the front side 103 of the body-covering portion 101 at at a common connection point with the first tie 107. In the illustrative embodiment of FIGS. 1 and 1, the tie members 107,108 are attached at a hip region of the gown 100. When the tie members 107,108 are tied across the opening 201, the body-covering portion 101 becomes “cinched” at the waist region about the wearer.

When a wearer dons the gown 100, they can wrap the first tie 107 around the front and left sides of their torso. They can also wrap the second tie 108 around the right side of their torso, tying the first tie 107 and the second tie 108 together behind them to close the opening 201. In this illustrative embodiment, the common connection point is offset on the front portion 103 of the body-covering portion to the right side of the gown 100. In another embodiment, the ties 107,108 can be attached at each side of the gown, with the second tie 108 then being as a mirror image of first tie 107.

In one embodiment, the one or more ties 107,108 each have a length of about 33.00″, minimum for a regular size, and about 38.00″, minimum, for the extra large size. These lengths facilitate a body-covering portion 101 having a sweep of between about 56.00″ and 60.00″ for the regular size and between about 60.00″ and 64.00″ for the extra large size. Each of the one or more ties 107,108 can be affixed to the body-covering portion 101 with a front tie attachment 109, which may be formed by ultrasonically welding the one or more ties 107,108 to the body-covering portion 101. In one embodiment, the front tie attachment 109 is disposed a distance of between about 17.00″ and 18.00″ below the front of the head insertion aperture for the regular size, and between about 18.00″ and 19.00″ below the front of the head insertion aperture for the extra large size.

In other embodiments, the ties 107,108 are replaced with other fasteners. Examples of such fasteners include hook and loop fasteners, adhesive tape fasteners, and the like. Moreover, some gowns have closures at the neck to provide an additional closure to that provided at the waist.

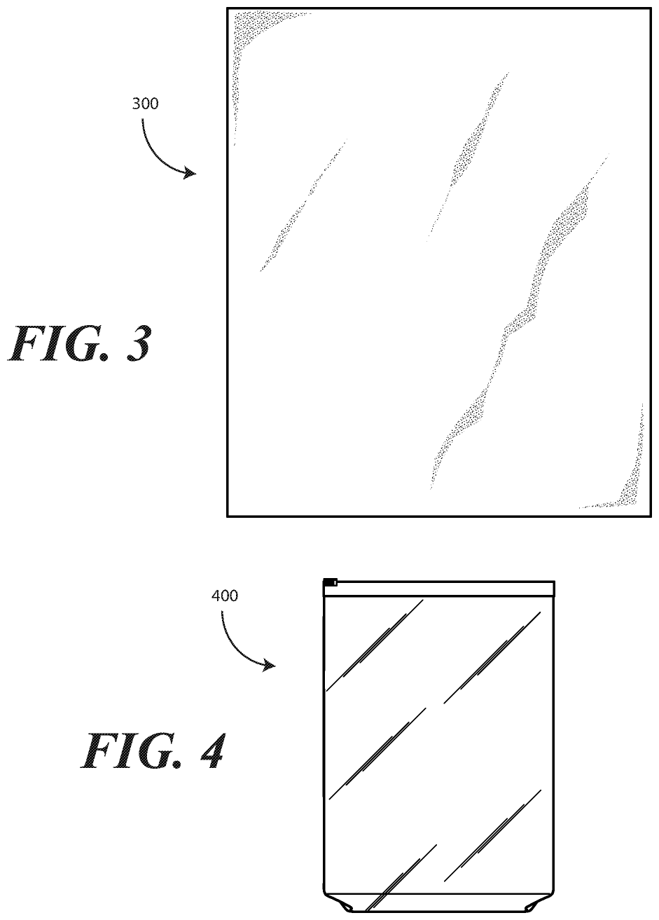

Turning now to FIG. 3, illustrated therein is one explanatory drape 300 configured in accordance with one or more embodiments of the disclosure. In FIG. 3, the drape 300 is in an unfolded state.

In one embodiment, the drape 300 is opaque. The drape 300 can be color-coded to indicate that it is designed for a particular procedure as well. For example, a particular color such as blue may indicate that the drape 300 is to be used for general patient exams. Other color-coding will be obvious to those of ordinary skill in the art having the benefit of this disclosure.

The drape 300 can be manufactured from any type of flat cloth, including those manufactured from any of woven materials, nonwoven materials, or combinations thereof. Examples of nonwoven materials include spunbound materials, meltblown materials, or combinations thereof. Additionally, the material weight of the drape 300 can vary as well. For example, in one illustrative embodiment the drape 300 is manufactured from a non-woven material having a weight of between ten and one hundred grams per square meter.

In another embodiment, the 300 can be manufactured from 60-gram, plus or minus two grams, spunbond-meltblown-spunbond material. Other materials can be used for the drape 300, including, for example, various woven, non-woven, hydroentangled materials, and/or combinations thereof, absorbent Airlaid, spunlace, blends of polyester, polypropylene, polyethylene, urethane, and/or combinations thereof, using various methods, including a spunbond meltblown spundbond (SMS) method, a spunbond meltblown metlblown spundbond method (SMMS), and a spunbond metlblown meltblown meltblownspundbond method (SMMMS). Other materials, such as plastic, cotton, linen, paper, or combinations thereof, can be substituted. In one or more embodiments, the drape 300 and the gown (100) are manufactured from the same material.

These materials and methods are illustrative only, as others will be readily apparent to those of ordinary skill in the art having the benefit of this disclosure. For example, one or more antimicrobial layers can be added to the drape 300 to further enhance antimicrobial protection. Additionally, the material can optionally include and water resistant lining that prevents the passage of fluids through the material of the drape 300. In one or more embodiments, the drape 300, when unfolded, has a length of between forty-six and fifty inches, such as about forty-eight inches. Other dimensions will be obvious to those of ordinary skill in the art having the benefit of this disclosure.

Turning now to FIG. 4, illustrated therein is one embodiment of a package 400 configured in accordance with one or more embodiments of the disclosure. In one or more embodiments, the package 400 includes a closure 401 that can be closed to keep the internal components uncontaminated or sterile. In other embodiments, the package 400 is not included for sterility, but is instead included to prevent the contents of the package 400 clean and undisturbed during distribution and use. In this illustrative embodiment, the closure 401 comprises a zip strip. However, other closures will be obvious to those of ordinary skill in the art having the benefit of this disclosure.

The package 400 can be manufactured from various materials. In one or more embodiments, the package 400 is transparent. Illustrating by example, in one embodiment the package 400 is manufactured as a transparent, zip-top bag from transparent polyethylene. Other types of material from which the package 400 can be manufactured will be obvious to those of ordinary skill in the art having the benefit of this disclosure.

In one or more embodiments, the package 400 includes a length and width suitable to hold a patient's street clothes. Embodiments of the disclosure contemplate that when a patient enters an examination room and is told to disrobe, there is frequently no designated place where they can put their street clothes. This only leaves them to pile them on a chair, on a counter, or just place them on the floor. Advantageously, in one or more embodiments the package 400 has dimensions that allow the patient to place their belongings in the package after removing its contents. The patient can then optionally seal the bag with the closure 401. In some embodiments, a handle or hanger can be added to the package such that the patient can hang the package 400 from the door,chair, or hook so that it is not lying in an awkward heap on the floor. Where the package 400 is so sized, the package 400 eliminates the problem of not knowing where to place one's clothes when asked to disrobe. In other embodiments, the dimensions of the package 400 will just be suitable to accommodate the drape (300) and gown (100) described above when folded. Other dimensions for the package 400 will be obvious to those of ordinary skill in the art having the benefit of this disclosure.

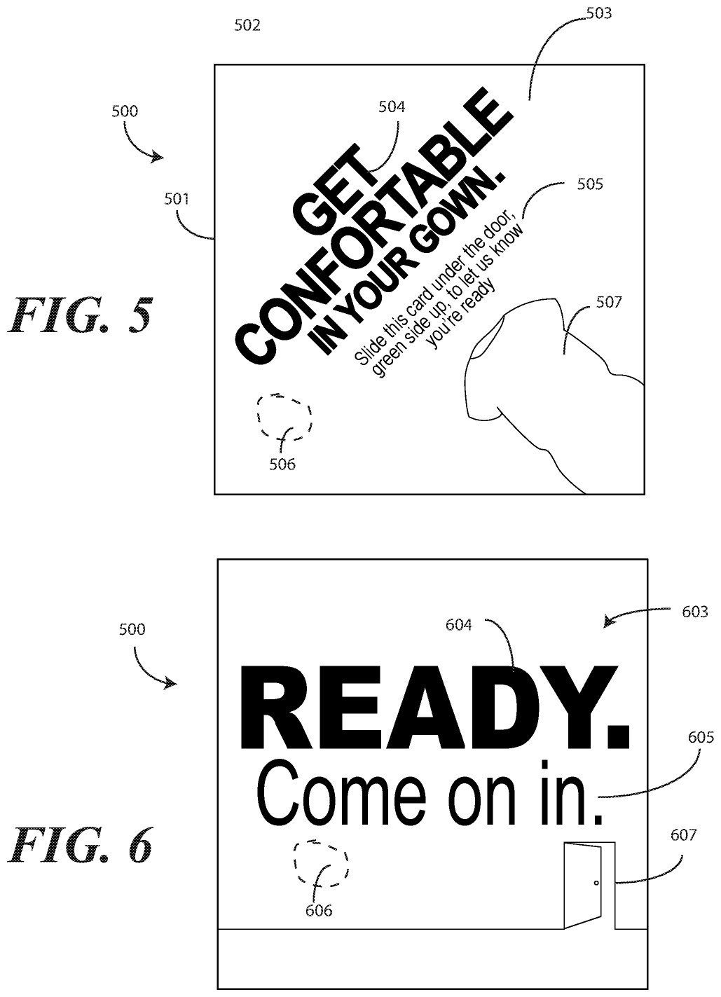

Turning now to FIGS. 5 and 6, illustrated therein is one explanatory handbill 500 configured in accordance with one or more embodiments of the disclosure. In one or more embodiments, the handbill 500 comprises a small notice that can be manipulated by hand. In one embodiment, the handbill 500 comprises a physical substrate 501. The physical substrate 501 can be manufactured from a variety of materials, including paper, cardboard, plastic, poster board, metal, or wood. Other materials from which the physical substrate 501 of the handbill 500 can be manufactured will be obvious to those of ordinary skill in the art having the benefit of this disclosure.

In one or more embodiments, the physical substrate 501 is rectangular. In one or more embodiments, the physical substrate 501 defines a first major face 502 and a second major face 602. Indicia can be placed on one or both of the first major face 502 and/or second major face 602.Other shapes can be used in manufacturing the handbill and will be obvious to those of ordinary skill in the art having the benefit of this disclosure.

In one embodiment, each of the first major face 502 and the second major face 602 includes a color background 506,606. For example, in one the first major face 502 comprises a first color background 506, while the second major face 602 comprising a second color background 606. In one or more embodiments, the first color background 506 and the second color background 606 are different. Illustrating by example, in one embodiment the first color background 506 is blue, while the second color background 606 is green. Other colors for backgrounds, fonts, and other aspects of the handbill 500 will be obvious to those of ordinary skill in the art having the benefit of this disclosure.

In this illustrative embodiment, the first major face 502 comprises an instruction 503 disposed thereon. In one or more embodiments, the instruction 503 comprises a welcoming instruction 504 and a functional instruction 505. In this illustrative embodiment, the welcoming instruction 504 is more prominently displayed along the first major face 502. For example, in one embodiment the welcoming instruction 504 can be in a larger font than the functional instruction 505. In another embodiment, the welcoming instruction 504 can be in a boldface font, while the functional instruction 505 is in a standard font. In another embodiment, the welcoming instruction 504 can be underscored, while the functional instruction 505 is not underscored. Other techniques of making the welcoming instruction 504 more prominent on the first major face 502 will be obvious to those of ordinary skill in the art having the benefit of this disclosure.

In one or more embodiments, the welcoming instruction 504 concerns the gown (100) described above. For example, in one embodiment the welcoming instruction 504 instructs a patient to “get comfortable” in the gown (100). In this illustration, the welcoming instruction 504 states, “Get Comfortable In Your Gown.” To demonstrate a functional connection between the gown (100) and the welcoming instruction 504, in one or more embodiments the first major face 502 of the handbill 500 further comprises a depiction 507 of the gown. In the illustrative embodiment of FIG. 5, the depiction 507 illustrates the gown in a donned state.

If the welcoming instruction 504 was directed to a drape rather than a gown, the welcoming instruction 504 might instruct the patient to “get comfortable” under the drape. Of course, combinations of the two welcoming instructions could be used as well.

Advantageously, the welcoming instruction 504 instructs a patient what to do with the gown 100, namely, put it on and get comfortable in it. Rather than the patient simply being put in a room and given a gown, thanks to the welcoming instruction 504 the patient knows instinctively what to do with the gown (100). Moreover, since the welcoming instruction 504 is inviting as well as informative, it provides a welcoming message that helps to reduce the patient's stress level. This is in addition to the welcoming instruction 504 informing the patient of exactly what to do with the gown (100), or drape (300), or both, as the case may be.

In one or more embodiments, the first major face 502 of the handbill 500 further comprises a functional instruction 505. In one or more embodiments, the functional instruction 505 indicates that there is a defined functional relationship between the instruction 503 and the physical substrate 501 of the handbill 500.

In one or more embodiments, the functional instruction 505 instructs a user to pass the physical substrate 501 beneath a door after donning the gown (100). Said differently, in one embodiment the functional instruction 505 instructs the user to pass the physical substrate 501 beneath a door after transforming the gown (100) from the folded state to a donned state. In one embodiment, the functional instruction 505 includes instruction comprising the words, “Slide this card under the door, green side up, to let us know you're ready.”

As is the case with the first major face 502, the second major face 602 can include indicia as well. In this illustrative embodiment, the second major face 602 includes a visual indicator 603 disposed thereon. In one or more embodiments, the visual indicator 603 comprises a notification 604 that the gown (100) has been transitioned from the folded state to a donned state. In this illustrative embodiment, the notification 604 includes the word, “Ready.” In this illustrative embodiment, the visual indicator 603 also includes a depiction 607 of the door.

In one or more embodiments, the visual indicator 603 also includes an instruction 605 instructing medical personnel to enter the door. In this illustrative embodiment, the instruction 605 states, “Come on in,” thereby advantageously alerting the medical personnel that the patient has disrobed, donned the gown (100) and optionally covered their exposed parts with the drape (300).

Thus, as shown in FIGS. 5 and 6, the handbill 500 comprises a visual indicator 603 that includes a notification 604 that the gown (100) has been transitioned from the folded state to the donned state. Additionally, the handbill 500 comprises a functional instruction 505 that instructs passage of the handbill beneath a door or other privacy structure, such as a curtain, after the transformation of the gown (100) from the folded state to the donned state has occurred. This inclusion of the functional instruction 505 and the visual indicator 603 thus defines a functional relationship between the physical substrate 501 and the visual indicator 603. This is true because the physical substrate 501 provides a vessel or physical vehicle that translates the visual indicator 603 beneath a door or other privacy structure, such as a curtain. Said differently, the physical substrate 501 serves as a translation instrument to transform the visual indicator 603 from an interior of a room, examination area or procedure area, where it cannot be seen by medical personnel, to an exterior of that location, where it can be seen by medical personnel, without opening the door or entering the location.

In one or more embodiments, the functional instruction 505 indicates that passage of the physical substrate 501 beneath the door, after transforming the gown (100) from the folded state to the donned state, should occur with the second major face 602 facing upward. In this illustration, the functional instruction 505 includes the words, “green side up,” indicating that the second major face 602 should be facing upward when the physical substrate 501 translates beneath the door. Accordingly, this functional instruction 505 the handbill 500 thus identifies the functional relationship between the visual indicator 603 and the handbill 500, namely, that the visual indicator 603 is an alert notice to medical personnel that is communicated to those medical personnel by the translation of the physical substrate 501 under the door.

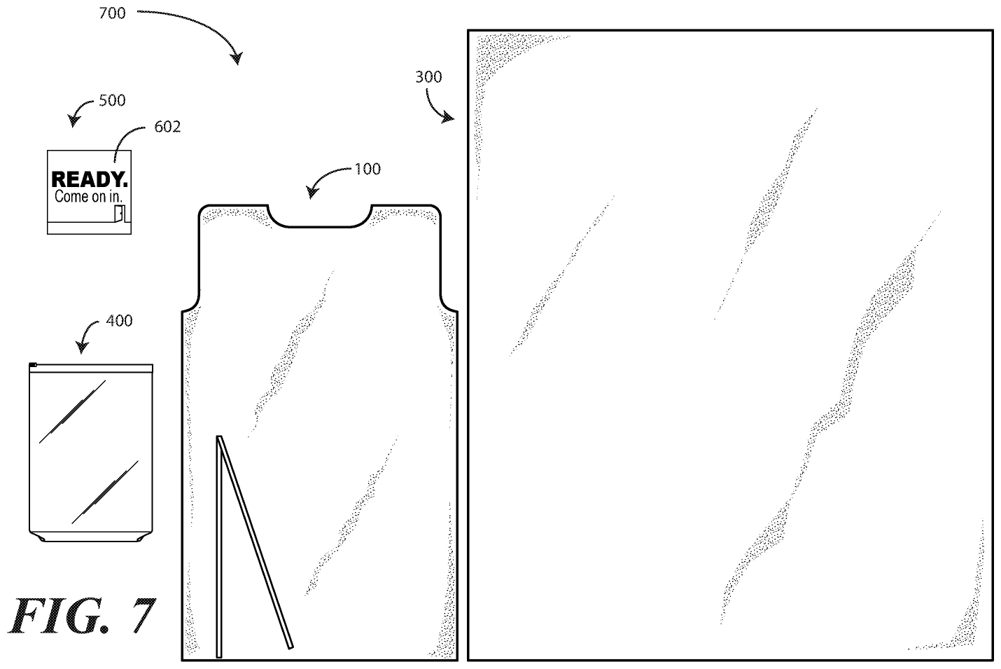

Turning now to FIG. 7, illustrated therein is one explanatory system 700 in accordance with one or more embodiments of the disclosure. As shown in FIG. 7, in one embodiment the system includes the package 400, shown here as a clear zip-strip bag, the gown 100, and the handbill 500. The system 700 can optionally include the drape 300. In other embodiments, the drape 300 will be omitted. In FIG. 7, both the gown 100 and the drape 300 are shown in their unfolded states. The handbill is shown with the second major face 602 facing upward.

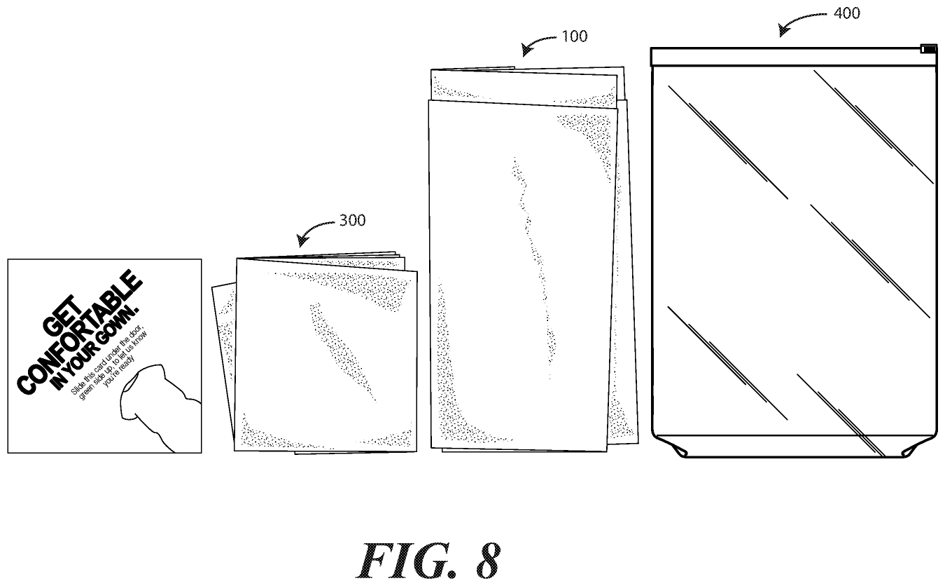

Turning now to FIG. 8, both the gown 100 and the drape 300 have been transformed from the unfolded state of FIG. 7 to the folded state. FIG. 8 provides an explanatory dimensional perspective for the package 400, as the transparent zip-strip bag is only slightly larger than the gown 100 in height and width in this embodiment when the gown 100 is in the folded state. As noted above, in other embodiments the package 400 can be larger so as to accommodate a patient's street clothes.

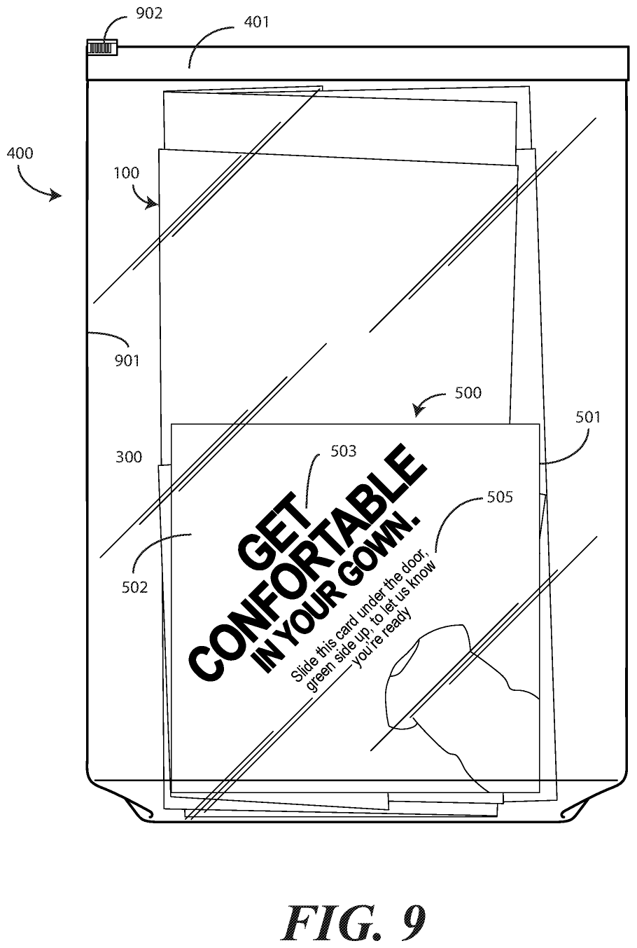

Turning now to FIG. 9, the gown 100, the drape 300, and the handbill 500 have all been placed, i.e., situated, within the package 400. Turning briefly to FIG. 11, illustrated therein is one such method 1000 for assembling the system of FIG. 9.

Beginning with step 1101, the method 1100 includes folding the gown. At step 1102, the method 1100 optionally includes folding the drape. Where the drape is omitted, step 1102 will be as well.

At step 1003, the method 1100 includes obtaining the handbill. As previously described, in one or more embodiments the handbill comprises an instruction disposed along a first major face to pass the handbill beneath a door after transforming the gown from a folded state to a donned state.

At step 1104, the method 1100 includes placing the gown, the drape, and the handbill in the transparent package. In one or more embodiments, step 1104 comprises placing the gown, the drape, and the handbill in the transparent package with the drape positioned between the handbill and the gown such that the instruction is visible through the transparent package.

At step 1105, the method 1100 optionally includes sealing the package to create a sealed system. Where, for example, the package includes a zip-strip, this step 1105 could include using a slider of the zip-strip to seal the package. Step 1106 then includes giving the sealed system, shown in FIG. 9, to a patient.

Turning now back to FIG. 9, in one embodiment when the system is sealed the gown 100 is in the folded state, as is the drape 300. The closure 401 has been closed using a slider 902 to seal the package 400. This allows the package 400 to keep the interior contents, which include the gown 100 in the folded state, the drape 300 in the folded state, and the handbill 500 clean and/or sterile.

In this illustrative embodiment, the drape 300 is positioned between the gown 100 and the handbill 500. In this embodiment, the first major face 502 of the handbill 500 abuts an interior surface 901 of the package 400. Since the package 400 is transparent in this embodiment, the first major face 502 of the handbill 500, and more importantly the instruction 503 disposed along the first major face 502 of the handbill 500 is fixable through the transparent sidewall of the package 400.

Advantageously, this allows a patient to see and read the instruction 503 through the package 400. Accordingly, a medical services provider can give the package to a patient upon entering an exam room. The patient is immediately welcomed and instructed by the welcoming instruction 504. At the same time, the patient is informed of the functional relationship between the visual indicator (603) on the second major face 602 of the handbill 500 and the physical substrate 501 by the functional instruction 505.

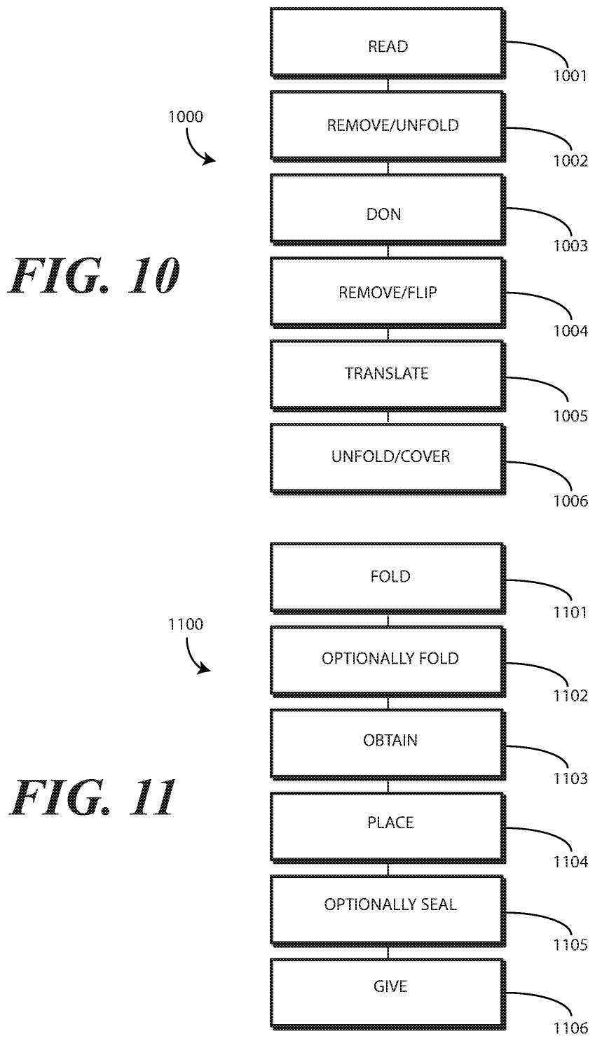

Turning now to FIG. 10, illustrated therein is one explanatory method 1000 for using the gown once the system has been received. Beginning at step 1001, the method 1000 includes the patient reading the instruction through the transparent package. As noted above, by performing step 1001, the patient is immediately welcomed and instructed by the welcoming instruction, while being informed of the functional relationship between the visual indicator on the second major face of the handbill and the physical substrate by the functional instruction.

At step 1002, the patient removes the gown and unfolds it, thereby transitioning it from the folded state to the unfolded state. Thereafter, at step 1003 the patient dons the gown as explained above with reference to FIG. 1, thereby transforming the gown from an unfolded state to a donned state.

At step 1004, to alert the health care services provider that the patient is ready for them to enter the area in which the patient is waiting, the patient removes the handbill from the package in accordance with the functional instruction on the first major face of the physical substrate. The patient then turns the handbill over in accordance with the functional instruction on the first major face of the physical substrate, thereby ensuring that the second major face of the handbill is facing upward.

At step 1005, the patient then translates the physical substrate of the handbill under a door or other privacy structure, such as a curtain, thereby sending the visual indicator disposed on the second major face of the physical substrate from an interior of the room to an exterior of the room. At step 1006, the patient optionally unfolds the drape and covers some or all of their body with the drape.

Thus, as shown and described, in one or more embodiments a handbill is sealed within the package such that a major face of the handbill is visible through the transparent package. In one or more embodiments, the handbill comprises an inviting instruction disposed on a first major face. In one or more embodiments, the instruction instructs the patient to “get comfortable” in their gown. Of course, combinations of these instructions could be used as well. Other instructions will be obvious to those of ordinary skill in the art having the benefit of this disclosure.

In addition to this instruction, in one or more embodiments the handbill also includes an instruction to pass the substrate beneath a door or other privacy structure, such as a curtain after transforming the gown from a folded state to a donned state. This instruction can further indicate passage of the substrate beneath the door or other privacy structure, such as a curtain after transforming the gown from the folded state to the donned state should occur with a second major face of the handbill facing upward. In one or more embodiments, the second major face of the handbill comprises a visual indicator. In one or more embodiments, the visual indicator comprises a notification that the gown has been transitioned from the folded state to a donned state.

Illustrating by example, the visual indicator disposed on the second major face of the handbill could include the words: “Ready. Come on in.” By using the handbill functionally as a physical vehicle to translate the visual indicator beneath the door, medical personnel are advantageously instantly alerted to the fact that the patient has disrobed, donned the gown and/or covered with the drape, and is ready for them enter. Advantageously, this eliminates the anxiety, the waiting, and makes the overall medical examination or procedure process more efficient.

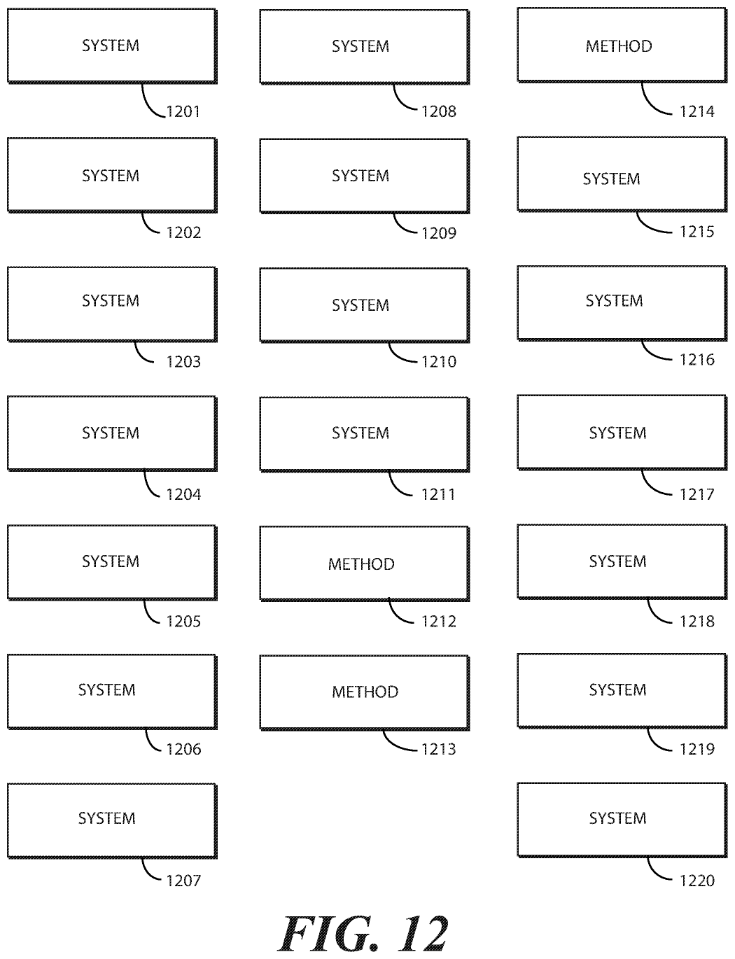

Turning now to FIG. 12, illustrated therein are various embodiments of the disclosure. At 1201, a system comprises a gown, a drape, and a handbill. At 1201, the handbill comprises a physical substrate defining a first major face and a second major face. At 1201, the system comprises a transparent package having situated therein the gown in a folded state, the drape in a folded state, and the handbill with the handbill abutting an interior surface of the package. At 1201, the handbill comprises an instruction disposed along the first major face to pass the substrate beneath a barrier after transforming the gown from the folded state to a donned state.

At 1202, the instruction of 1201 is visible through the transparent package. At 1023, the instruction of 1202 indicates that passage of the substrate beneath the door, after transforming the gown from the folded state to the donned state, should occur with the second major face facing upward.

At 1204, the first major face of 1203 comprises a first color background. At 1204, the second major face of 1203 comprises a second color background. In one or more embodiments at 1204, the first color background and the second color background are different. For example, the first color background could be blue while the second color background is green, and so forth.

At 1205, the system of 1203 further comprises a drape. At 1205, the transparent package further has situated therein the drape in a folded state. In one or more embodiments at 1205, the drape is positioned between the gown and the handbill.

At 1206, the instruction of 1203 instructions a patient to get comfortable in the gown. At 1207, the instruction of 1206 further comprises a depiction of the gown.

At 1208, the handbill of 1206 further comprises a visual indicator disposed along the second major face of the physical substrate. At 1208, the visual indicator comprises a notification that the gown has been transitioned from the folded state to a donned state.

At 1209, the visual indicator of 1208 further instructs medical personnel to enter through the barrier, which can be a door, curtain, or other barrier. At 1210, the visual indicator of 1209 further comprises a depiction of the barrier. At 1211, the package of 1206 further comprises a closure to seal the package when the gown in the folded state, the drape in the folded state, and the handbill are situated within the package.

At 1212, a method comprises folding a gown. At 1212, the method optionally includes folding a drape. At 1212, the method includes obtaining a handbill. In one embodiment at 1212 the handbill comprises an instruction disposed along a first major face to pass the handbill beneath a door after transforming the gown from a folded state to a donned state. At 1212, the method comprises placing the gown, the drape, and the handbill in a transparent package with the drape positioned between the handbill and the gown such that the instruction is visible through the transparent package.

At 1213, the method of 1212 further comprises sealing the package to create a sealed system. At 1214, the method of 1213 further comprises delivering the sealed system to a patient.

At 1215, a system comprises a gown, a handbill, and a package. At 1215, the package comprises situated therein the gown in a folded state and the handbill.

At 1215, the handbill comprises a visual indicator comprising a notification that the gown has been transitioned from the folded state to a donned state. At 1215, the handbill defines a functional relationship to the visual indicator by providing a physical vehicle to translate the visual indicator beneath a door.

At 1216, the handbill of 1215 further comprises an instruction identifying the functional relationship between the visual indicator and the handbill. At 1217, the instruction of 1216 instructs passage of the handbill beneath a door after transforming the gown from the folded state to a donned state.

At 1218, the instruction of 1217 is disposed along a first major face of the handbill. At 1218, the visual indicator of 1217 is disposed along a second major face of the handbill.

At 1219, the gown of 1217 defines a sleeveless gown with a plurality of ties coupled to a front side of the disposable gown. At 1220, the instruction of 1217 comprising the words, “Slide this card under the door, green side up, to let us know you're ready.” At 1229, the visual indicator of 1217 comprises the words, “Ready” and “Come on in.”

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example, while packages described above include a single handbill, other packages may include multiple handbills as necessary for a particular procedure. For instance, if a patient passes one handbill under a door or curtain, another could be included in the package to provide directions to the patient about a specific procedure, e.g., “now that you have donned the gown, please sit on the exam table,” and so forth.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A system, comprising:
a gown;
a drape;
a handbill comprising a physical substrate defining a first major face and a second major face; and
a transparent package having situated therein the gown in a folded state, the drape in a folded state, and the handbill with the handbill abutting an interior surface of the package;
the handbill comprising an instruction disposed along the first major face to pass the substrate beneath a barrier after transforming the gown from the folded state to a donned state.

2. The system of claim 1, wherein the instruction is visible through the transparent package.

3. The system of claim 2, the instruction indicating passage of the substrate beneath the door after transforming the gown from the folded state to the donned state with the second major face facing upward.

4. The system of claim 3, the first major face comprising a first color background, the second major face comprising a second color background, wherein the first color background and the second color background are different.

5. The system of claim 3, further comprising a drape, the transparent package further having situated therein the drape in a folded state, wherein the drape is positioned between the gown and the handbill.

6. The system of claim 3, the instruction further instructing a patient to get comfortable in the gown.

7. The system of claim 6, the instruction further comprising a depiction of the gown.

8. The system of claim 6, the handbill further comprising a visual indicator disposed along the second major face, the visual indicator comprising a notification that the gown has been transitioned from the folded state to a donned state.

9. The system of claim 8, the visual indicator further instructing medical personnel to enter.

10. The system of claim 9, the visual indicator further comprising a depiction of the barrier.

11. The system of claim 6, the package further comprising a closure to seal the package when the gown in the folded state, the drape in the folded state, and the handbill are situated within the package.

12. A method, comprising:
folding a gown;
folding a drape;
obtaining a handbill comprising an instruction disposed along a first major face to pass the handbill beneath a door after transforming the gown from a folded state to a donned state; and
placing the gown, the drape, and the handbill in a transparent package with the drape positioned between the handbill and the gown such that the instruction is visible through the transparent package.

13. The method of claim 12, further comprising sealing the package to create a sealed system.

14. The method of claim 13, further comprising delivering the sealed system to a patient.

15. A system, comprising:
a gown;
a handbill; and
a package comprising the gown in a folded state and the handbill;
wherein the handbill comprises a visual indicator comprising a notification that the gown has been transitioned from the folded state to a donned state; and
the handbill defines a functional relationship to the visual indicator by providing a physical vehicle to translate the visual indicator beneath a door.

16. The system of claim 15, the handbill further comprising an instruction identifying the functional relationship between the visual indicator and the handbill.

17. The system of claim 16, instruction instructing passage of the handbill beneath a door after transforming the gown from the folded state to a donned state.

18. The system of claim 17, the instruction disposed along a first major face of the handbill, the visual indicator disposed along a second major face of the handbill.

19. The system of claim 17, the gown defining a sleeveless gown with a plurality of ties coupled to a front side of the disposable gown.

20. The system of claim 17, the instruction comprising the words, “Slide this card under the door, green side up, to let us know you're ready,” the visual indicator comprising the words, “Ready” and “Come on in.”
